(19) United States
(12) Patent Application Publication
(10) Pub. No.: US 2014/0328712 A1
(43) Pub. Date: Nov. 6, 2014

(54) Vacuum heat treatment method and equipment for NdFeB rare earth permanent magnetic devices

(71) Applicant: China North Magnetic & Electronic Technology Co., LTD, Shenyang (CN)

(72) Inventor: Haotian Sun, Shenyang (CN)

(73) Assignee: China North Magnetic & Electronic Technology Co., LTD, Shenyang (CN)

(21) Appl. No.: 14/024,590

(22) Filed: Sep. 11, 2013

(30) Foreign Application Priority Data
May 5, 2013 (CN) 201310160444.7

(51) Int. Cl. H01F 41/02; H01F 1/053

(52) U.S. Cl. CPC H01F 41/0266; H01F 1/0536
USPC 419/27; 148/101; 419/28; 266/250

(57) ABSTRACT

A vacuum heat treatment method for NdFeB rare earth permanent magnetic devices and an equipment thereof are disclosed. A rotary vacuum heat treatment equipment is for processing the NdFeB rare earth permanent magnetic devices with a vacuum heat treatment and obviously improves magnetic performance of the NdFeB rare earth permanent magnetic device, especially coercivity, which facilitates reducing a usage of heavy rare earth elements and protecting rare earth resources. Thus the vacuum heat treatment method and the equipment thereof are able to manufacture high-performance rare earth permanent magnetic devices.

### BACKGROUND OF THE PRESENT INVENTION

1. Field of Invention

The present invention relates to permanent magnetic devices, and more particularly to a vacuum heat treatment method for neodymium-iron-boron (NdFeB) rare earth permanent magnetic devices and a rotary vacuum heat treatment equipment thereof.

2. Description of Related Arts

The NdFeB rare earth permanent magnetic material is more and more applied in fields of the medical nuclear magnetic resonance imaging, the computer hard disk drive, the acoustic device and the mobile phone because of the good magnetic performance thereof. Under the requirements of saving energy and the low carbon economy, the NdFeB rare earth permanent magnetic material is further applied in fields of the auto parts, the household appliances, the energy-saving control motors, the hybrid power automobiles and the wind generators.

In 1982, the Japanese Sumitomo Special Metals Co. Ltd firstly disclosed the Japanese patents of the NdFeB rare earth permanent magnetic materials, 1,622,492 and 2,137,496, and then submitted the U.S. patent application and the European application thereof, which disclosed the features of the NdFeB rare earth permanent magnetic material, the ingredient thereof and the preparation method thereof and confirmed the main phase of Nd₂Fe₁₄B phase and the grain boundary phase of rich Nd phase, rich B phase and rare earth oxide (REO) impurities.

On Apr. 1, 2007, the Japanese Hitachi Metals merged with the Japanese Sumitomo Metals and inherited the rights and obligations of the patent license about the NdFeB rare earth permanent magnet of the Sumitomo Metals. On Aug. 17, 2012, the Hitachi Metals claimed the ownership of the U.S. Pat. No. 6,461,565, U.S. Pat. No. 6,491,765, U.S. Pat. No. 6,537,385 and U.S. Pat. No. 6,527,874 for the law suit in United States International Trade Commission (ITC).

### SUMMARY OF THE PRESENT INVENTION

With the enlarged application market of the NdFeB rare earth permanent magnetic material, the shortage of rare earth resources is increasingly serious, especially in the fields which need increased heavy rare earth to improve coercivity, such as the electronic devices, the energy-saving control motors, the auto parts, the new energy automobiles and the wind generators. Thus, how to reduce the usage of rare earth, especially the usage of heavy rare earth, remains to be an important issue. After researching, the present invention provides a manufacture method of high-performance NdFeB rare earth permanent magnetic devices.

The present invention adopts following technical solutions.

A NdFeB rare earth permanent magnetic device has an alloy comprising R—Fe—B-M,

wherein R represents at least one of rare earth elements;

Fe represents element Fe;

B represents element B; and

M represents at least one member selected from a group consisting of elements Al, Co, Nb, Ga, Zr, Cu, V, Ti, Cr, Ni and Hf.

A manufacture method of the NdFeB rare earth permanent magnetic device comprises steps of:

(1) melting an alloy,

wherein the alloy is melted via an art of ingot casting which comprises steps of: heating raw materials of a NdFeB rare earth permanent magnetic alloy to melt into an alloy at a molten state and casting the alloy at the molten state into water-cooled casting molds to form alloy ingots in a vacuum or a protective atmosphere, and further comprises a step of controlling a thickness of the ingots between 1˜20 mm by moving or rotating the casting molds; or the alloy is melted via an art of strip casting which comprises steps of: firstly heating an alloy to be molten, then casting the molten alloy fluid into a rotary roller having a water cooling via a tundish, and cooling the molten alloy by the rotary roller to form alloy sheets, wherein the rotary roller has a cooling speed of 100˜1000° C./S and the post-cooling alloy sheet, further comprises a step of secondarily cooling the alloy sheets when the alloy sheets leave the rotary roller and then falls into a rotary drum or onto a rotating plate which is provided below the rotary roller and above an inert gas cooling device having a heat exchanger and a mechanical stirring device, and preferably further comprises a step of preserving heat in a secondarily cooling device after the alloy sheets leave the rotary roller and before the alloy sheets are secondarily cooled, wherein a heat preservation time is usually between 10˜120 minutes and a heat preservation temperature is between 550˜400° C.;

(2) coarsely pulverizing the alloy, wherein

the alloy is pulverized mainly by mechanically pulverizing or hydrogen pulverizing, wherein the mechanically pulverizing comprises a step of pulverizing the alloy ingots into granules having a particle size smaller than 5 mm under a protection of nitrogen via a powder manufacturing device, such as a jaw crusher, a hammer crusher, a ball mill, a rod mill and a disc mill, wherein the alloy sheets are usually directly pulverized under the protection of nitrogen via the powder manufacturing device like the ball mill, the rod mill, the disc mill, rather than the jaw crusher and the hammer crusher, to grind coarse granules of the alloy sheets obtained from Step (1) into the fine granules having the particle size smaller than 5 mm;

the hydrogen pulverizing comprises steps of: firstly feeding the alloy sheets and the alloy ingots into a vacuum hydrogen pulverizing furnace, evacuating the vacuum hydrogen pulverizing furnace, then introducing hydrogen therein for a hydrogen absorption by the alloys therein, wherein a hydrogen absorption temperature is usually lower than 200° C. and a hydrogen absorption pressure is usually between 50˜200 KPa, evacuating the vacuum hydrogen pulverizing furnace again after the hydrogen absorption is completed, then heating for a dehydrogenation, wherein a dehydrogenation temperature is usually between 600˜900° C., and finally cooling powder after the dehydrogenation in a vacuum or a protective atmosphere which is usually argon;

or the hydrogen pulverizing comprises steps of: feeding the alloy ingots or the alloy sheets into a rotary drum, evacuating the rotary drum, then introducing hydrogen therein for a hydrogen absorption by the alloys until the alloys are saturated, stop introducing, maintaining for more than 10 minutes, evacuating again, then heating and rotating the rotary drum to dehydrogenate in a vacuum at a dehydrogenation temperature between 600˜900° C. and thereafter cooling the rotary drum; or

the hydrogen pulverizing is accomplished via a method of rare earth permanent magnetic alloy hydrogen pulverization continuous manufacture which comprises steps of: providing a device comprising a hydrogen absorption cavity, a heating and dehydrogenating cavity, a cooling cavity, inter-cavity separating valves, a load box, a transmitting device and an evacuating device, wherein the hydrogen absorption cavity, the heating and dehydrogenating cavity and the cooling cavity are respectively connected via the inter-cavity separating valves; the transmitting device is provided at upper parts of the hydrogen absorption cavity, the heating and dehydrogenating cavity and the cooling cavity; and the load box is hung on the transmitting device and repeatedly transmitted successively through the hydrogen absorption cavity, the heating and dehydrogenating cavity and the cooling cavity along the transmitting device; then loading the alloy ingots or the alloy sheets into the hanging load box; transmitting the loaded alloy ingots or the loaded alloy sheets successively through the hydrogen absorption cavity, the heating and dehydrogenating cavity and the cooling cavity to successively absorb hydrogen, be heated to dehydrogenated and be cooled; and finally feeding the alloys into a load-storing tank in a vacuum or a protective atmosphere;

(3) producing alloy powder, comprising steps of:

providing a jet mill which comprises a feeder, a milling cavity having a nozzle at a lower part and a sorting wheel at an upper part, a weighing system for controlling a weight of powder load fed into the milling cavity and a feeding speed, a cyclone collector, a powder filter and a gas compressor, wherein nitrogen is usually used as operation gas and a pressure of compressed gas is between 0.6˜0.8 MPa; adding coarse powder obtained from Step (2) into the feeder of the jet mill, feeding the coarse powder into the milling cavity under a control by the weighing system, grinding the coarse powder with a high-speed airflow ejected via the nozzle, then raising the ground powder up with the airflow, collecting the powder which meet a powder manufacture requirement and enter the cyclone collector via the sorting wheel and continuing grinding the powder which fail to meet the powder manufacture requirement and return to the lower part of the milling cavity under a centrifugal force; and collecting the powder which enter the cyclone collector as finished products by a collector provided at a lower part of the cyclone collector, filtering fine powder which are discharged along with the airflow since the cyclone collector fails to collect all of the powder which enter the cyclone collector by the filter and collecting the fine powder by a fine powder collector provided at a lower part of the filter;

wherein usually a weight percentage of the fine powder is smaller than 15% and a particle size of the fine powder is smaller than 1 μm; a rare earth content of the fine powder is higher than an average rare earth content of the powder and thus the fine powder are readily oxidized and usually discarded as waste; thus Step (3) further comprises steps of: feeding the fine powder and the powder which are collected by the cyclone collector into a two-dimensional mixer or a three-dimensional mixer to mix while controlling an oxygen content of a protective atmosphere below 50 ppm and magnetically compacting the mixture in the protective atmosphere, wherein the mixing lasts for more than 30 minutes and the oxygen content is lower than 50 ppm; preferably Step (3) comprises the step of collecting the fine powder which are discharged out of the cyclone collector along with the airflow by a fine powder collector which is provided between the cyclone collector and the filter, wherein usually 10% of the fine powder can be collected and are fed into a two-dimensional mixer or a three-dimensional mixer with the powder which are collected by the cyclone collector to mix and magnetically compacted in the protective atmosphere; because of the high content of rare earth of the fine powder, the fine powder are suitable to be a rich rare earth phase of a grain boundary phase and facilitate improving magnetic performance; and

in order to further improve the magnetic performance, after Steps (1) and (2) of respectively melting alloys of a plurality of ingredients of the NdFeB rare earth permanent magnetic device and coarsely pulverizing the respective alloys, Step (3) further comprises steps of: producing powder of the respective alloys, mixing the respective powder and then magnetically compacting the mixture;

(4) compacting,

wherein a key difference between compacting the NdFeB rare earth permanent magnet and compacting a common powder metallurgy is to compact in an oriented magnetic field and thus an electromagnet is provided on a press; according to prior arts, the compacting is preferred to accomplished at an ambient temperature between 5˜35° C. while controlling a relative humidity between 40%˜65% and an oxygen content between 0.02˜5% because the powder of the NdFeB rare earth permanent magnet are readily oxidized; and

in order to prevent the powder from oxidizing, Step (4) comprises steps of providing a protective box having a pair of gloves and magnetically compacting the powder in a protective atmosphere, and further comprises steps of: providing a cooling system in a magnetic space within the protective box to form a temperature-controlled magnetic field compacting space, providing molds within a low temperature space and compacting the powder at the controlled temperature, wherein the temperature is controlled between −15˜20° C., preferably below 5° C.; the oxygen content within the protective box is controlled below 200 ppm, preferably at 100 ppm; an oriented magnetic field intensity within a cavity of the mold is usually controlled between 1.5˜3 T; the powder are pre-oriented before being compacted and the oriented magnetic field intensity is maintained during compacting; and the oriented magnetic field is constant, pulsating or alternating; and in order to reduce a compacting pressure, Step (4) further comprises a step of isostatically pressing; and

(5) sintering, comprising steps of:

sintering in a vacuum sintering furnace in a vacuum or an argon protective atmosphere at a temperature between 1000˜1200° C., then preserving heat usually for 0.5˜20 hours and thereafter cooling with argon or nitrogen;

further comprising steps of: providing a transmitting box having a valve and a pair of gloves, sending compacted alloy packs obtained from Step (4) into the transmitting box in a protective atmosphere, introducing protective gas into the protective box, removing external packages of the alloy packs and thereafter loading the alloy packs into a sintering load box in the protective gas, then switching on a valve between the transmitting box and the sintering furnace and finally transmitting the load box which is loaded with the alloy packs to be sintered via a transmitting mechanism of the transmitting box into the vacuum sintering furnace to sinter;

wherein preferably the vacuum sintering furnace is a multi-cavity vacuum sintering furnace having different vacuum cavities respectively for degassing, sintering and cooling; the transmitting box having the pair of glove is connected to the several vacuum cavities via the valve; and the load box successively passes through the several vacuum cavities; and

further comprising a step of processing with aging treatment once or twice to improve magnet coercivity, wherein the once aging treatment is usually executed at a temperature between 400˜700° C. and the twice aging treatment is usually executed at a high temperature between 800˜1000° C. and at a low temperature between 400˜700° C.; and the alloy packs after the aging treatment are processed with machining and surface treatment.

A vacuum heat treatment method of the NdFeB rare earth permanent magnetic device, provided by the present invention, comprises steps of:

firstly machining a sintered NdFeB rare earth permanent magnetic device according to finished size and shape or substantially finished size and shape of the NdFeB rare earth permanent magnetic device; removing oil, cleaning and drying; and then feeding the NdFeB rare earth permanent magnetic device into a rotary drum of a rotary vacuum heat treatment equipment. A plurality of balls and grains which contain rare earth elements are provided within the rotary drum, wherein the rare earth elements comprise Dy, Tb, Pr and Nd. The rotary vacuum heat treatment equipment comprises an evacuating unit, a gas cooling device and a vacuum furnace body; a thermal insulating layer is provided inside the vacuum furnace body and a heater is further provided inside the thermal insulating layer; at least one rotary drum is provided inside the heater; and the rotary drum has a plurality of reinforcing plates continually or interruptedly provided therein, wherein the reinforcing plate is straight or spiral. The rotary drum is supported by a supportive wheel which is able to rotate actively or passively, wherein the rotary drum has a drum axle which drives the drum to rotate provided at an end part if the supportive wheel is able to rotate passively; the rotary drum has a rotating axle provided at an end part and is supported by the rotating axle at the end part. Preferably, the end part of the rotary drum has a cover. The rotary drum is made of at least one layer of material. If the rotary drum is made of more than one layer of material, an internal layer thereof is metal. A powering device for driving the rotary drum to rotate is provided at an external part of the thermal insulating layer. The thermal insulating layer has a plurality of spraying nozzles which are respectively intercommunicated with an airflow path of the gas cooling device, wherein the gas for cooling is sprayed onto the rotary drum via the spraying nozzles.

The rotary vacuum heat treatment equipment has an operation process comprising steps of: evacuating; heating and rotating the rotary drum which rotates at a direction or rotates alternatively at two directions until reaching a heat preservation temperature; preserving heat; and when preserving heat is completed, cooling the rotary drum with gas, wherein the foregoing heating, preserving heat and cooling can be repeated; a vacuum degree of the vacuum heat treatment is controlled between 5 Pa and 5×10⁻³ Pa; the heat preservation temperature is between 600˜1000° C., wherein a heat preservation temperature lower than 600° C. leads to unobvious effects and a heat preservation temperature higher than 1000° C. leads to transformation; a heat preservation time is controlled between 0.5˜20 hours, wherein a heat preservation time shorter than 0.5 hour leads to unobvious effects and a heat preservation time longer than 20 hours leads to unobvious improvement in coercivity; the gas for cooling after preserving heat is a protective gas; after cooling, the rotary drum is heated again to increase the temperature to 400˜700° C., preserves heat for 0.5˜12 hours and then cooled with argon.

In order to satisfy requirements of size, precision and corrosion resistance, the NdFeB rare earth permanent magnetic device is selectively post-processed with grinding, chamfering, sand blasting, electroplating, electrophoresis, spray coating and vacuum coating after the vacuum heat treatment.

The manufacture method of high-performance NdFeB rare earth permanent magnetic devices, provided by the present invention, is applicable in the production of high-performance rare earth permanent magnetic materials, especially the motor magnet of the new energy automobiles, the motor magnet of the household appliances, the energy-saving motor magnet, the motor and the sensor magnets of the auto parts, the magnet of the hard disk drive and the magnet of the electronic electro-acoustic device. The vacuum heat treatment, provided by the present invention, obviously improves the coercivity of the rare earth permanent magnets without changing the content of heavy rare earth, so as to save and protect the rare earth resources.

These and other objectives, features, and advantages of the present invention will become apparent from the following detailed description, the accompanying drawings, and the appended claims.

### BRIEF DESCRIPTION OF THE DRAWINGS

FIG. 1 is a sketch view of a rotary vacuum heat treatment equipment according to preferred embodiments of the present invention.

FIG. 2 is a sketch view of the rotary vacuum heat treatment equipment having a plurality of rotary drums according to the preferred embodiments of the present invention.

FIG. 3 is a sketch view of the rotary vacuum heat treatment equipment without supportive wheel according to the preferred embodiments of the present invention.

FIG. 4 is a sketch view of the rotary drum having the supportive wheels and a rotating axle provided at an end part according to the preferred embodiments of the present invention.

FIG. 5 is a sketch view of the rotary drum whose supportive wheels are able to rotate actively according to the preferred embodiments of the present invention.

FIG. 6 is a sketch view of the rotary drum supported by the rotating axle at the end part according to the preferred embodiments of the present invention.

1—gas cooling device; 2—spraying nozzle; 3—heater; 4—thermal insulating layer; 5—vacuum furnace body; 6—evacuating unit; 7—rotary drum; 8—load material; 9—supportive wheel; 10—drum axle; 11—reinforcing plate; 12—cover; 13—supportive wheel axle.

### DETAILED DESCRIPTION OF THE PREFERRED EMBODIMENT

The present invention is further illustrated via a comparison between examples.

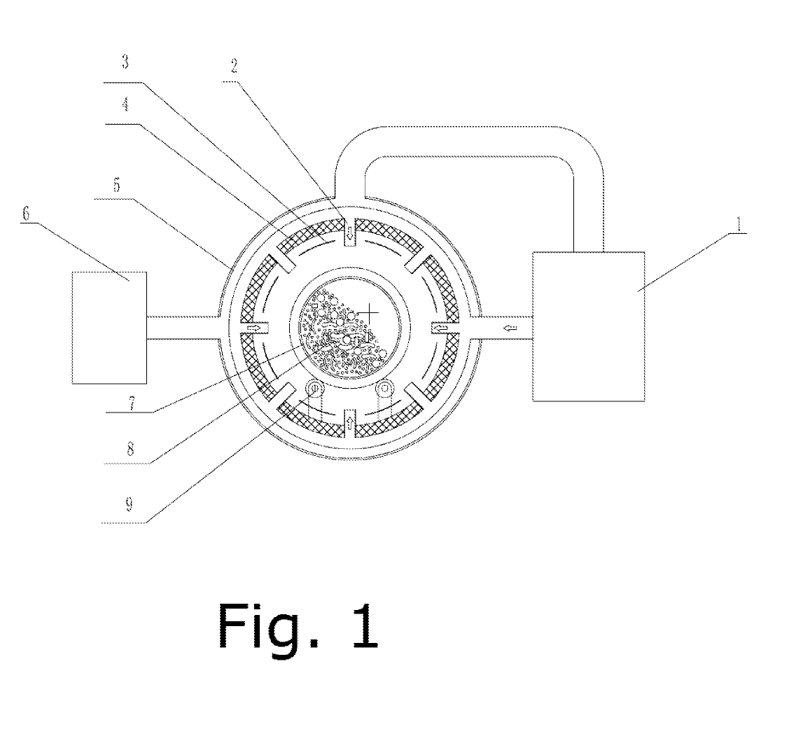

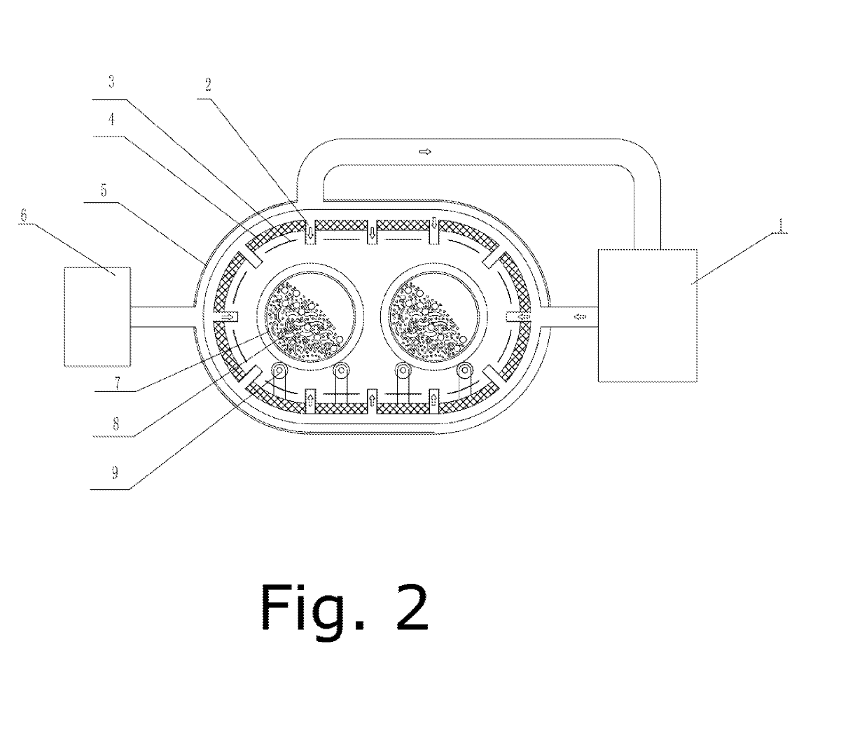

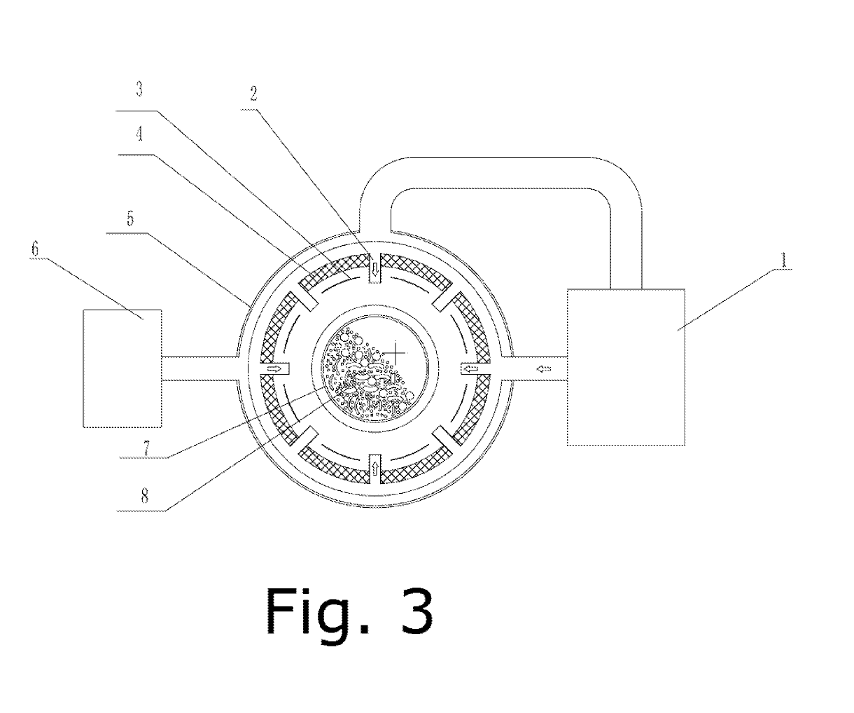

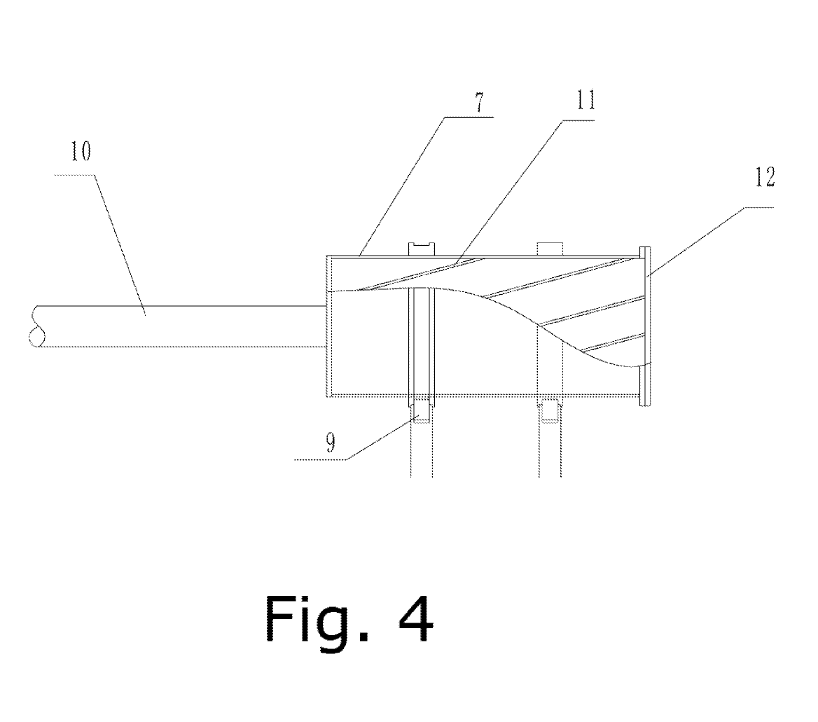

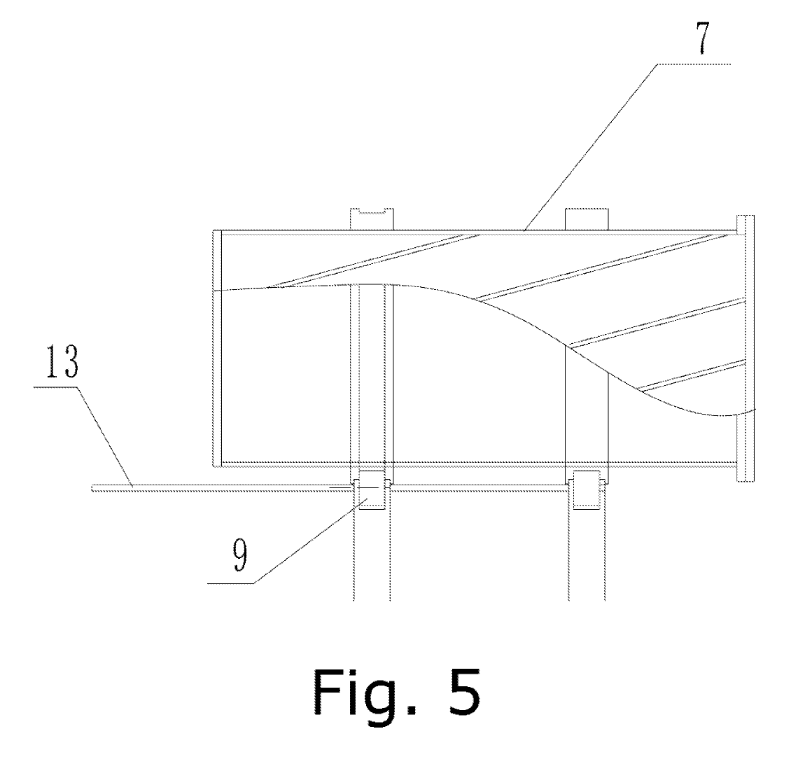

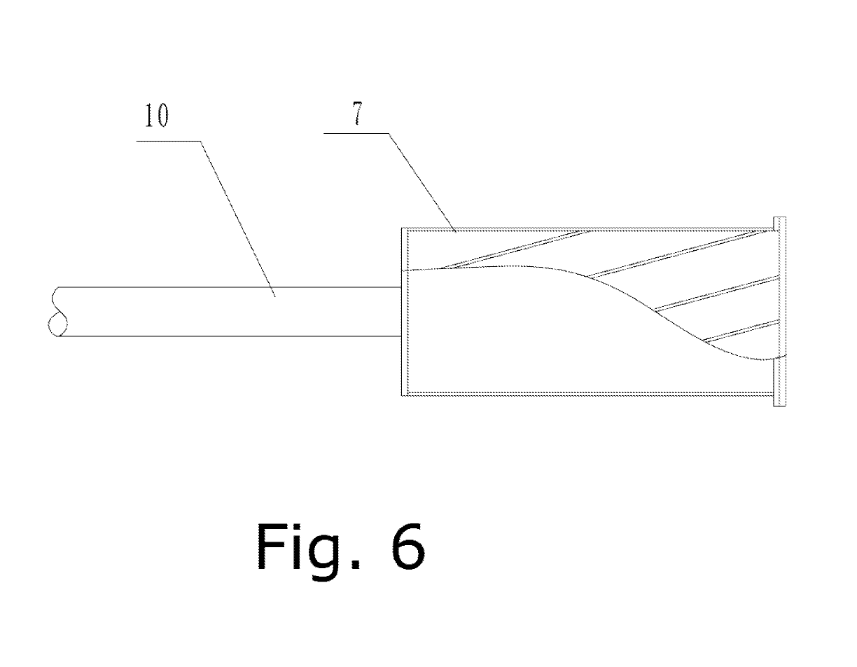

Referring to FIGS. 1-6 of the drawings, according to preferred embodiments of the present invention, a rotary vacuum heat treatment equipment comprises an evacuating unit 6, a gas cooling device 1 and a vacuum furnace body 5. A thermal insulating layer 4 is provided inside the vacuum furnace body 5. The thermal insulating layer 4 has a plurality of spraying nozzles 2 which are respectively intercommunicated with a pipeline of the gas cooling device 1; a heater 3 is provided inside the thermal insulating layer 4 and a rotary drum 7 is provided inside the heater 3, in such a manner that gas for cooling is cooled by the gas cooling device 1 and then sprayed onto the rotary drum 7. A plurality of reinforcing plates 11 are continually or interruptedly provided inside the rotary drum 7, wherein the reinforcing plate 11 is straight or spiral. As showed in FIG. 4, the rotary drum 7 is supported by supportive wheels 9 and driven to rotate via a drum axle 10. As showed in FIG. 5, the rotary drum 7 is supported by supportive wheels 9 and driven to rotate via a supportive wheel axle 13. As showed in FIG. 6, the rotary drum 7 is supported by a drum axle 10 and driven to rotate via the drum axle 10. A cover 12 is provided at an end of the rotary drum 7. The rotary drum 7 is made of at least one layer of materials. If the rotary drum 7 is made of more than one layer of materials, an internal layer thereof is metal. Load material 8 comprising NdFeB rare earth permanent magnetic devices, balls and grains containing rare earth elements are provided inside the rotary drum 7. Preferably, the rotary vacuum heat treatment equipment comprises more than one rotary drum 7.

### Example 1

Melting 600 Kg of an alloy according to ingredient A of Table 1 and casting the alloy at a molten state into a rotating cooling roller having water cooling to obtain alloy sheets; coarsely pulverizing the alloy sheets by a vacuum hydrogen pulverizing furnace; when the hydrogen pulverizing is completed, producing powder by a jet mill; compacting in an oriented magnetic field by a press to obtain magnet packs having a size of 62×52×42 mm at an oriented direction of 42 inches; after the compacting is completed, isostatically pressing; feeding the magnet packs into a vacuum sintering furnace to sinter at 1060° C. and then cooling to 80° C. via recycling argon; taking the magnet packs out of the vacuum sintering furnace and machining the magnet packs respectively into four scales: big-sized sheets (60×25×10), small-sized sheets (30×20×3), sectors (R30×r40, radian 60°, thickness 5) and concentric tiles (R60×r55, chord length 20, height 30); after removing oil, cleaning and drying, feeding the magnets of the four scales, as well as balls and grains containing rare earth elements, into a rotary drum of a rotary vacuum heat treatment equipment; evacuating to a vacuum degree of 5×10⁻¹ Pa and then starting to heat and rotate the rotary drum while controlling the vacuum degree above 5×10⁻¹ Pa; starting to preserve temperature when the temperature reaches 950° C.; after preserving the temperature for 2 hours, cooling with argon to 100° C.; then heating again to 480° C. and preserving the temperature for 4 hours; thereafter cooling with argon until the temperature is lower than 80° C. and then taking the magnets of the four scales out of the rotary vacuum heat treatment equipment.

In order to satisfy requirements of size, precision and corrosion resistance, the magnets of the four scales are selectively post-processed with grinding, chamfering, sand blasting, electroplating, electrophoresis, spray coating and vacuum coating. Detection results of magnetic performance of the magnets of the four scales are showed in Table 2.

### Example 2

Melting 600 Kg of an alloy according to ingredient B of Table 1 and casting the alloy at a molten state into a rotating cooling roller having water cooling to obtain alloy sheets which leave the cooling roller and falls onto a rotating plate; mechanically stirring and cooling with argon within the rotating plate; then coarsely pulverizing the alloy sheets by a vacuum hydrogen pulverizing furnace; when the hydrogen pulverizing is completed, producing powder by a jet mill whose oxygen content is controlled at 10 ppm; compacting in an oriented magnetic field having an intensity of 1.8 T by a press in protective nitrogen to obtain magnet packs having a size of 62×52×42 mm at an oriented direction of 42 inches and packaging the compacted magnet packs in a protective box having an oxygen content of 90 ppm; isostatically pressing and then feeding the magnet packs into a vacuum sintering furnace to sinter at 1060° C. and then cooling to 80° C. via recycling argon; taking the magnet packs out of the vacuum sintering furnace and machining the magnet packs respectively into four scales: big-sized sheets (60×25×10), small-sized sheets (30×20×3), sectors (R30×r40, radian 60°, thickness 5) and concentric tiles (R60×r55, chord length 20, height 30); after removing oil, cleaning and drying, feeding the magnets of the four scales, as well as balls and grains containing rare earth elements, into a rotary drum of a rotary vacuum heat treatment equipment; evacuating to a vacuum degree of 5×10⁻¹ Pa and then starting to heat and rotate the rotary drum while controlling the vacuum degree above 5×10⁻¹ Pa; starting to preserve temperature when the temperature reaches 850° C.; after preserving the temperature for 10 hours, cooling with argon to 100° C.; then heating again to 450° C. and preserving the temperature for 6 hours; thereafter cooling with argon until the temperature is lower than 80° C. and then taking the magnets of the four scales out of the rotary vacuum heat treatment equipment.

In order to satisfy requirements of size, precision and corrosion resistance, the magnets of the four scales are selectively post-processed with grinding, chamfering, sand blasting, electroplating, electrophoresis, spray coating and vacuum coating. Detection results of magnetic performance of the magnets of the four scales are showed in Table 2.

### Example 3

Melting 600 Kg of an alloy according to ingredient C of Table 1 and casting the alloy at a molten state into a rotating cooling roller having water cooling to obtain alloy sheets which leave the cooling roller and falls into a rotary drum; preserving a temperature of the rotary drum for 30 minutes and thereafter cooling the rotary drum; then feeding the alloy sheets into a hydrogen absorption tank, evacuating, then introducing hydrogen therein for a hydrogen absorption by the alloy sheets; when the alloy sheets are saturated, stopping introducing; then feeding the saturated alloys into a rotary vacuum heat treatment equipment to dehydrogenate at a dehydrogenating temperature of 900° C.; after the dehydrogenation is completed, cooling with argon; coarsely pulverizing the alloy sheets by a vacuum hydrogen pulverizing furnace; when the hydrogen pulverizing is completed, producing powder by a jet mill whose oxygen content is controlled at 30 ppm; mixing the powder collected by a cyclone collector with the powder collected by a powder filter for 60 minutes via a two-dimensional mixer under a protection of nitrogen; thereafter feeding the mixture into an oriented magnetic field to be compacted into magnet packs at an oriented direction of 42 inches by a press in protective nitrogen, wherein the oriented magnetic field has an intensity of 1.8 T; a temperature within mold cavities is controlled at 3° C.; and the magnet packs have a size of 62×52×42 mm; packaging the compacted magnet packs in a protective box having an oxygen content of 110 ppm; taking the packaged magnet packs out of the protective box and isostatically pressing at an isostatic pressure of 200 MPa; then feeding the magnet packs into a vacuum sintering furnace to sinter at 1060° C. and then cooling to 80° C. via recycling argon; taking the magnet packs out of the vacuum sintering furnace and machining the magnet packs respectively into four scales: big-sized sheets (60×25×10), small-sized sheets (30×20×3), sectors (R30×r40, radian 60°, thickness 5) and concentric tiles (R60×r55, chord length 20, height 30); after removing oil, cleaning and drying, feeding the magnets of the four scales, as well as balls and grains containing rare earth elements, into a rotary drum of a rotary vacuum heat treatment equipment; evacuating to a vacuum degree of 5×10⁻¹ Pa and then starting to heat and rotate the rotary drum while controlling the vacuum degree above 5 Pa; starting to preserve temperature when the temperature reaches 750° C.; after preserving the temperature for 20 hours, cooling with argon to 100° C.; then heating again to 500° C. and preserving the temperature for 3 hours; thereafter cooling with argon until the temperature is lower than 80° C. and then taking the magnets of the four scales out of the rotary vacuum heat treatment equipment.

In order to satisfy requirements of size, precision and corrosion resistance, the magnets of the four scales are selectively post-processed with grinding, chamfering, sand blasting, electroplating, electrophoresis, spray coating and vacuum coating. Detection results of magnetic performance of the magnets of the four scales are showed in Table 2.

### Example 4

Melting 600 Kg of an alloy according to ingredient D of Table 1 and casting the alloy at a molten state into a rotating cooling roller having water cooling to obtain alloy sheets which leave the cooling roller and falls into a rotary drum; preserving a temperature of the rotary drum for 30 minutes and thereafter cooling the rotary drum; coarsely pulverizing the alloy sheets by a vacuum hydrogen pulverizing furnace; when the hydrogen pulverizing is completed, producing powder by a jet mill whose oxygen content is controlled at 30 ppm; mixing the powder collected by a cyclone collector with the powder collected by a fine powder collector for 60 minutes via a two-dimensional mixer under a protection of nitrogen; thereafter feeding the mixture into an oriented magnetic field to be compacted into magnet packs at an oriented direction of 42 inches by a press in protective nitrogen, wherein the oriented magnetic field has an intensity of 1.8 T; a temperature within mold cavities is controlled at −5° C.; and the magnet packs have a size of 62×52×42 mm; packaging the compacted magnet packs in a protective box having an oxygen content of 110 ppm; taking the packaged magnet packs out of the protective box and isostatically pressing at an isostatic pressure of 200 MPa; then feeding the magnet packs into a vacuum sintering furnace to sinter at 1060° C. and then cooling to 80° C. via recycling argon; taking the magnet packs out of the vacuum sintering furnace and machining the magnet packs respectively into four scales: big-sized sheets (60×25×10), small-sized sheets (30×20×3), sectors (R30×r40, radian 60°, thickness 5) and concentric tiles (R60×r55, chord length 20, height 30); after removing oil, cleaning and drying, feeding the magnets of the four scales, as well as balls and grains containing rare earth elements, into a rotary drum of a rotary vacuum heat treatment equipment; evacuating to a vacuum degree of 5×10⁻¹ Pa and then starting to heat and rotate the rotary drum while controlling the vacuum degree above 5 Pa; starting to preserve temperature when the temperature reaches 650° C.; after preserving the temperature for 20 hours, cooling with argon to 100° C.; then heating again to 500° C. and preserving the temperature for 3 hours; thereafter cooling with argon until the temperature is lower than 80° C. and then taking the magnets of the four scales out of the rotary vacuum heat treatment equipment.

In order to satisfy requirements of size, precision and corrosion resistance, the magnets of the four scales are selectively post-processed with grinding, chamfering, sand blasting, electroplating, electrophoresis, spray coating and vacuum coating. Detection results of magnetic performance of the magnets of the four scales are showed in Table 2.

TABLE 1

| order | name | ingredient |
|---|---|---|
| 1 | A | Nd30Dy1Fe67.9B0.9Al0.2 |
| 2 | B | Nd30Dy1Fe67.5Co1.2Cu0.1B0.9Al0.1 |
| 3 | C | (Pr0.2Nd0.8)25Dy5Fe67.4Co1.2Cu0.3B0.9Al0.2 |
| 4 | D | (Pr0.2Nd0.8)25Dy5Tb1Fe65Co2.4Cu0.3B0.9Al0.2Ga0.1Zr0.1 |

TABLE 2
Detection Results of Magnetic Performance after Heat Treatment

| | | | packaging | | | |
|---|---|---|---|---|---|---|
| | | | amount | surface | remanence | |
| order | name | scale | (pack/box) | treatment | (Gs) | coercivity (Oe) |
| Example 1 | A | big-sized | 180 | electroplating | 13970 | 17994 |
| | | sheet | | | | |
| Example 1 | A | small- | 500 | electrophoresis | 13810 | 17699 |
| | | sized | | | | |
| | | sheet | | | | |
| Example 1 | A | sector | 400 | phosphating | 13983 | 17551 |
| Example 1 | A | concentric | 300 | spray coating | 13975 | 17787 |
| | | tile | | | | |
| Example 2 | B | big-sized | 180 | electroplating | 13979 | 17841 |
| | | sheet | | | | |
| Example 2 | B | small- | 500 | electrophoresis | 13991 | 17616 |
| | | sized | | | | |
| | | sheet | | | | |
| Example 2 | B | sector | 400 | phosphating | 13995 | 17670 |
| Example 2 | B | concentric | 300 | spray coating | 14014 | 17977 |
| | | tile | | | | |
| Example 3 | C | big-sized | 180 | electroplating | 12598 | 28660 |
| | | sheet | | | | |
| Example 3 | C | small- | 500 | electrophoresis | 12565 | 29230 |
| | | sized | | | | |
| | | sheet | | | | |
| Example 3 | C | sector | 400 | phosphating | 12540 | 28750 |
| Example 3 | C | concentric | 300 | spray coating | 12590 | 28670 |
| | | tile | | | | |
| Example 4 | D | big-sized | 180 | electroplating | 12630 | 28830 |
| | | sheet | | | | |
| Example 4 | D | small- | 500 | electrophoresis | 12580 | 29240 |
| | | sized | | | | |
| | | sheet | | | | |
| Example 4 | D | sector | 400 | phosphating | 12640 | 28920 |
| Example 4 | D | concentric | 300 | spray coating | 12595 | 28810 |
| | | tile | | | | |

### Example 5

Melting 600 Kg of an alloy according to ingredient A of Table 1 and casting the alloy into casting ingots having a thickness of 12 mm; and processing the casting ingots as Example 1.

Melting 600 Kg of an alloy according to ingredient B of Table 1 and casting the alloy into casting ingots having a thickness of 12 mm; and processing the casting ingots as Example 2.

Melting 600 Kg of an alloy according to ingredient C of Table 1 and casting the alloy into casting ingots having a thickness of 12 mm; and processing the casting ingots as Example 3.

Melting 600 Kg of an alloy according to ingredient D of Table 1 and casting the alloy into casting ingots having a thickness of 12 mm; and processing the casting ingots as Example 4.

Table 3 shows detection results of magnetic performance of magnets originated from the casting ingots.

TABLE 3
Detection Results of Magnetic Performance after Heat Treatment

| | | | packaging | | rema- | coer- |
|---|---|---|---|---|---|---|
| | | | amount | surface | nence | civity |
| order | name | scale | (pack/box) | treatment | (Gs) | (Oe) |
| 1 | A | big- | 180 | electroplating | 13962 | 17473 |
| | | sized | | | | |
| | | sheet | | | | |
| 2 | A | small- | 500 | electrophoresis | 13904 | 17178 |
| | | sized | | | | |
| | | sheet | | | | |
| 3 | A | sector | 400 | phosphating | 13961 | 17084 |
| 4 | A | concentric | 300 | spray coating | 13987 | 17267 |
| | | tile | | | | |
| 5 | B | big- | 180 | electroplating | 13950 | 17321 |
| | | sized | | | | |
| | | sheet | | | | |
| 6 | B | small- | 500 | electrophoresis | 13987 | 17143 |
| | | sized | | | | |
| | | sheet | | | | |
| 7 | B | sector | 400 | phosphating | 13962 | 17165 |
| 8 | B | concentric | 300 | spray coating | 14031 | 17478 |
| | | tile | | | | |
| 9 | C | big- | 180 | electroplating | 12561 | 28565 |
| | | sized | | | | |
| | | sheet | | | | |
| 10 | C | small- | 500 | electrophoresis | 12559 | 28767 |
| | | sized | | | | |
| | | sheet | | | | |
| 11 | C | sector | 400 | phosphating | 12548 | 28235 |
| 12 | C | concentric | 300 | spray coating | 12576 | 28154 |
| | | tile | | | | |
| 13 | D | big- | 180 | electroplating | 12598 | 28343 |
| | | sized | | | | |
| | | sheet | | | | |
| 14 | D | small- | 500 | electrophoresis | 12579 | 28731 |
| | | sized | | | | |
| | | sheet | | | | |
| 15 | D | sector | 400 | phosphating | 12618 | 28422 |
| 16 | D | concentric | 300 | spray coating | 12565 | 28790 |
| | | tile | | | | |

Comparison 1

Melting 600 Kg of an alloy according to ingredient A of Table 1 and casting the alloy into casting ingots having a thickness of 12 mm; hydrogen pulverizing; producing powder by a jet mill which has a oxygen content of 30 ppm; collecting powder via a cyclone collector and a powder filter, which are showed in Table 4; mixing the powder collected by the cyclone collector with the powder collected by the powder filter for 30 minutes in a protective nitrogen via a two-dimensional mixer; sending the mixture into an oriented magnetic field to be compacted into magnet packs at an oriented direction of 42 inches by a press in protective nitrogen, wherein the oriented magnetic field has an intensity of 1.8 T; a temperature within mold cavities is controlled at 3° C.; and the magnet packs have a size of 62×52×42 mm; packaging the compacted magnet packs in a protective box having an oxygen content of 90 ppm; taking the packaged magnet packs out of the protective box and isostatically pressing at an isostatic pressure of 200 MPa; feeding the magnet packs into a vacuum sintering furnace to sinter at 1060° C. and processing with aging treatments twice respectively at 850° C. and at 580° C.

The alloys of ingredient B, C and D are respectively processed identically to the alloy of ingredient A. Table 4 shows detection results of magnetic performance of magnets originated from the casting ingots.

TABLE 4
Detection Results of Magnetic Performance of Magnets of Casting
Ingots

| | | | weight | | | |
|---|---|---|---|---|---|---|
| | | weight of | of fine | amount of | | |
| | | powder | powder | added fine | remanence | coercivity |
| order | name | (Kg) | (Kg) | powder (Kg) | (Gs) | (Oe) |
| 1 | A | 530 | 40 | 40 | 13965 | 14565 |
| 2 | B | 535 | 35 | 35 | 14000 | 14400 |
| 3 | C | 540 | 30 | 30 | 12390 | 25320 |
| 4 | D | 540 | 30 | 30 | 12560 | 26500 |

Comparison 2

Melting 600 Kg of an alloy according to ingredient A of Table 1 and casting the alloy at a molten state into a rotating cooling roller having water cooling to form alloy sheets; coarsely pulverizing the alloy sheets by a vacuum hydrogen pulverizing furnace; after the hydrogen pulverizing is completed, producing powder by a jet mill which has an oxygen content of 30 ppm; collecting powder via a cyclone collector and a fine powder collector, which are showed in Table 5; mixing the powder collected by the cyclone collector with the powder collected by the fine powder collector for 30 minutes in a protective nitrogen via a two-dimensional mixer; sending the mixture into an oriented magnetic field to be compacted into magnet packs at an oriented direction of 42 inches by a press in protective nitrogen, wherein the oriented magnetic field has an intensity of 1.8 T; a temperature within mold cavities is controlled at 3° C.; and the magnet packs have a size of 62×52×42 mm; packaging the compacted magnet packs in a protective box having an oxygen content of 110 ppm; taking the packaged magnet packs out of the protective box and isostatically pressing at an isostatic pressure of 200 MPa; feeding the magnet packs into a vacuum sintering furnace to sinter at 1060° C. and processing with aging treatments twice respectively at 850° C. and at 580° C.

The alloys of ingredient B, C and D are respectively processed identically to the alloy of ingredient A. Table 5 shows detection results of magnetic performance of magnets originated from the strip casting alloys.

TABLE 5
Detection Results of Magnetic Performance of Magnets of Strip
Casting Alloys

| | | | weight | | | |
|---|---|---|---|---|---|---|
| | | weight of | of fine | amount of | | |
| | | powder | powder | added fine | remanence | coercivity |
| order | name | (Kg) | (Kg) | powder (Kg) | (Gs) | (Oe) |
| 1 | A | 535 | 35 | 40 | 14112 | 15563 |
| 2 | B | 545 | 30 | 35 | 14180 | 15500 |
| 3 | C | 545 | 30 | 30 | 12540 | 26230 |
| 4 | D | 545 | 30 | 30 | 12680 | 27800 |

By comparisons among the Examples and comparisons between the Example and the Comparison, it is obvious that the coercivity of the rare earth permanent magnetic device via the vacuum heat treatment method and equipment provided by the present invention is higher than that of the product provided by the Comparison. The vacuum heat treatment method and the equipment thereof are able to manufacture high-performance rare earth permanent magnetic materials and devices.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A vacuum heat treatment method for NdFeB rare earth permanent magnetic devices, comprising steps of:
feeding NdFeB rare earth permanent magnetic devices into a rotary drum of a rotary vacuum heat treatment equipment for a heat treatment and simultaneously feeding balls and grains which contain rare earth elements therein; evacuating and then heating and rotating the rotary drum which rotates at a direction or rotates alternatively at two directions; when a temperature of the rotary drum reaches a heat preservation temperature, starting to preserving the temperature; when preserving the temperature is completed, cooling the rotary drum and a combination of the NdFeB rare earth permanent magnetic devices, the balls and the grains provided inside the rotary drum.

2. The method, as recited in claim 1, wherein a vacuum degree of the heat treatment is controlled between 5 Pa and 5×10⁻³ Pa; the heat preservation temperature is between 600˜1000° C.; the preserving temperature lasts for 0.5˜20 hours; after preserving the temperature, the rotary drum is cooled with argon; thereafter the temperature of the rotary drum reaches 400˜700° C. by heating again, preserved for 0.5˜12 hours and then cooled with argon.

3. The method, as recited in claim 1, further comprising steps of melting, coarsely pulverizing, producing powder, compacting and sintering before the vacuum heat treatment; and further comprising step of grinding, chamfering, sand blasting, electroplating, electrophoresizing, spray coating and vacuum coating after the vacuum heat treatment.

4. The method, as recited in claim 3, wherein the step of melting comprises steps of: heating raw materials to melt the raw materials into alloys via a vacuum induction in a vacuum or a protective atmosphere; casting the alloys at a molten state into a rotating cooling roller having a water cooling to form alloy sheets which leave the cooling roller and falls into a rotary drum or onto a rotating plate; and cooling the alloy sheets.

5. The method, as recited in claim 3, wherein the step of coarsely pulverizing comprises steps of: feeding alloy ingots or alloy sheets into a rotary drum; evacuating and then introducing hydrogen for a hydrogen absorption by the alloys; when the alloys are saturated, stopping introducing; maintain the saturated alloys for more than 10 minutes and then starting to evacuate again; heating and rotating the rotary drum to dehydrogenate in a vacuum at a dehydrogenation temperature of 600˜900° C.; and thereafter cooling the rotary drum.

6. The method, as recited in claim 3, wherein the powder is produced by a jet mill; the powder are collected by a cyclone collector; fine powder having a particle size smaller than 1 μm which are discharged with gas inside the cyclone collector are collected by a fine powder collector or a fine powder filter provided behind the cyclone collector; then the powder and the fine powder are mixed; and the jet mill has a milling cavity which has an oxygen content within 50 ppm.

7. The method, as recited in claim 3, wherein the step of compacting comprises a step of compacting in a magnetic field in protective gas at a temperature lower than 5° C., wherein the magnetic field is provided inside a protective box which has an oxygen content lower than 200 ppm.

8. The method, as recited in claim 3, further comprising steps of processing with aging treatment and then machining, after sintering and before the vacuum heat treatment.

9. The method, as recited in claim 1, wherein the vacuum heat treatment comprises at least one cycle of heating, preserving the temperature and cooling, wherein the cooling is to cool with gas.

10. A vacuum heat treatment equipment for NdFeB rare earth permanent magnetic devices, comprising an evacuating unit, a gas cooling device and a vacuum furnace body, wherein a thermal insulating layer is provided inside said vacuum furnace body; a heater is provided inside said thermal insulating layer; at least one rotary drum is provided inside said heater.

11. The equipment, as recited in claim 10, further comprising a plurality of reinforcing plates which are provided inside said rotary drum; and a plurality of balls and grains containing rare earth elements which are provided inside said rotary drum.

12. The equipment, as recited in claim 10, further comprising a supportive wheel for supporting said rotary drum, in such a manner that said rotary drum is driven to rotate by said supportive wheel.

13. The equipment, as recited in claim 10, further comprising a drum axle, provided at an end part of said rotary drum, for supporting said rotary drum, in such a manner that said rotary drum is driven to rotate by said rotary axle.

14. The equipment, as recited in claim 10, further comprising a drum axle provided at an end part of said rotary drum, in such a manner that said rotary drum is supported by a supportive wheel and driven to rotate by said drum axle.

15. The equipment, as recited in claim 10, wherein said thermal insulating layer has a plurality of spraying nozzles which are intercommunicated with an airflow path of said gas cooling device, in such a manner that gas for cooling is sprayed onto said rotary drum via said spraying nozzles.
